(19) United States
(12) Patent Application Publication
(10) Pub. No.: US 2021/0372074 A1
(43) Pub. Date: Dec. 2, 2021

(54) Foundation Repair Method

(71) Applicant: Malcolm H Hodge, Philadelphia, PA (US)

(72) Inventor: Malcolm H Hodge, Philadelphia, PA (US)

(21) Appl. No.: 16/972,582

(22) PCT Filed: Jun. 5, 2019
(86) PCT No.: PCT/US19/35610

§ 371 Date: Dec. 5, 2020

Related U.S. Application Data
(60) Provisional application No. 62/680,924, filed on Jun. 5, 2018.

(51) Int. Cl. E02D 35/00; E02D 5/64; E02D 37/00

(52) U.S. Cl. CPC E02D 35/005; E02D 2600/40; E02D 37/00; E02D 5/64

(57) ABSTRACT

A foundation lifting method includes the steps of cutting an existing concrete pile below the building foundation, inserting two sleeve portions over ends of the cut pile, placing a lifting device, such as a jack, between the ends of the cut pile and jacking vertically within the cut out section, and then fixing the two sleeve portions to reinforce the cut area. The method can be performed simultaneously or consecutively on plural existing concrete piles below the building foundation. The sleeve portion couples the lower pile portion with the upper pile portion to resist vertical and transverse loads. A computerized interface can coordinate the actuation scheme for multiple piles.

The application claims the benefit of U.S. Provisional Application No. 62/680,924, filed Jun. 5, 2018.

### BACKGROUND

Under certain soil conditions, tall buildings that are supported on friction piles can experience tilting as the piles settle at different rates. In one situation a multistory condominium building in a congested city block is tilting to an unacceptable degree. This building is supported on 950 friction piles. Current plans to true the building include the drilling, within the building basement, 50 to 100 new piles to a depth to be supported on bedrock. The estimated cost of this remediation is $100-200 million dollars.

Prior art patents disclose various schemes to raise foundations. U.S. Pat. No. 2,451,777 describes a sleeve for surrounding two concrete portions and pumping concrete under pressure into the sleeve to lift the upper concrete part, and thus the building. U.S. Pat. No. 2,322,855 discloses a method where a hydraulic jack is used to lift a foundation. These patents require either a new pier or support to support the jack or the drilling down to effectively create a new pier against bedrock.

The present inventor has recognized the desirability of providing a method to level a foundation that is supported on concrete piers or piles that is cost effective and minimizes disruption in the ordinary use of the building during remediation. The present inventor has recognized the desirability of providing a method that is effective to level high rise buildings, supported on concrete friction piles.

### SUMMARY

One exemplary method of the invention provides a foundation lifting method that includes the steps of cutting an existing concrete pile below the building foundation, inserting two sleeve portions over ends of the cut pile, placing a lifting device, such as a jack, between the ends of the cut pile and jacking vertically within the cut out section, and then fixing the two sleeve portions to reinforce the cut area. The method can be performed simultaneously or consecutively on plural existing concrete piles below the building foundation. The sleeve portion couples the lower pile portion with the upper pile portion to resist vertical and transverse loads.

The sleeve portions can comprise male and female threaded sleeve portions that can be threaded together to reinforce the cut area.

The invention comprises a method of raising a building in the situation where the building is supported on piers or piles and has settled to an undesirable extent. The method includes removing an upper section of piles one at a time. Steel sleeves with male and female threads are slipped over the upper and lower ends of the pile where the concrete has been removed. Mechanical or hydraulic jacks are inserted into the space where concrete was removed. The jacks are either raised or lowered in small increments to level the building. The jacks can be left in place or replaced by shims. The two steel sleeves can be slid together and screwed together. The lower sleeve and or the upper sleeve can be pinned to the pile to provide lateral and vertical stability. Hydraulic or electrically driven actuators can be used remotely and coordinate pile height adjustment, with the further option for a computerized interface to coordinate the actuation scheme.

In a further aspect of the invention, wedge shaped shims can be used in lieu of jacks. A module is placed between cut ends of the pile. The module includes a housing with a top wall, a bottom wall and two side walls. The top wall is braced against a lower face of the top pile portion and the bottom wall is braced against an upper face of the lower pile portion. The shims are stacked in the housing between the top wall and the bottom wall in interleaving, opposite directions with the narrow ends toward the middle of the housing. Studs are threaded through the side walls wherein threading of the studs into the housing drives the wedge thick ends inward. This elevates the top wall from the bottom wall and raises a top portion of the pile which raises the top portion of the pile.

In a further aspect of the invention a strain gauge is attached to at least the upper pile portion. The strain gauge is used to measure the initial load taken up by a particular pile as well as the load on the pile during a lifting operation. Displacement gauges on the lower pile portion and the upper pile portion can be used during the leveling process and to access pile reaction to an earthquake load.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1A is a schematic profile view of a building foundation supported on piles;

FIG. 1B is a schematic profile view of the building foundation of FIG. 1A after upper portions of the piles have been removed and replaced by jacks;

FIG. 1C is a schematic profile view of the building foundation of FIG. 1B after the jacks have been selectively lowered to level the foundation;

FIGS. 2A-2D are schematic profile views of steps of another method of adjusting the elevation of a foundation supported on piles;

FIG. 3 is a perspective view of a portion of FIG. 2D;

FIGS. 4A-4F are schematic profile views of steps of another method of adjusting the elevation of a foundation supported on piles;

FIG. 5 is an exploded perspective view of a sleeve taken from FIG. 4F;

FIG. 6 is a schematic sectional view of another method of adjusting the elevation of a foundation supported on piles;

FIG. 7 is a schematic sectional view taken generally along line 7-7 of FIG. 6; and

FIG. 8 is a schematic sectional view of another method of adjusting the elevation of a foundation supported on piles.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

This specification incorporates by reference U.S. Provisional Application No. 62/680,924, filed Jun. 5, 2018.

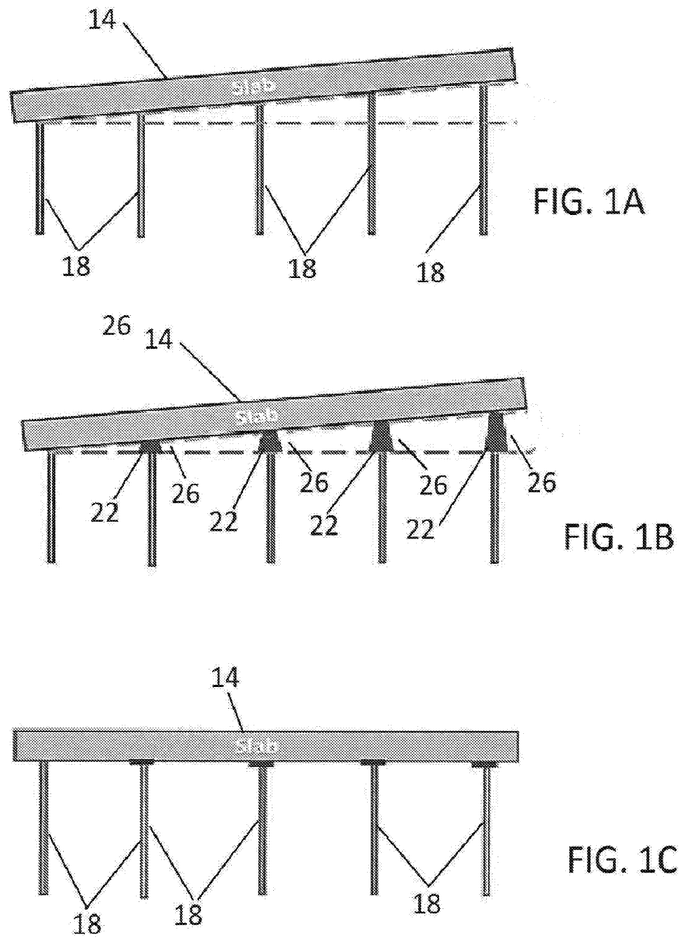

FIGS. 1A through 1C illustrate a general method according to the invention. Shown in FIG. 1A is a building foundation slab 14 supported on piles 18. The slab 14 is canted due to uneven settling of the piles 18. In the illustrated embodiment there is an increasing amount of settling in the piles moving from left to right.

FIG. 1B illustrates that upper sections of the piles 18 have been removed creating gaps 26. Jacks 22 are interposed within the gaps.

In a next step shown in FIG. 1C, the jacks are lowered by an increasing amount moving from left to right to level the slab.

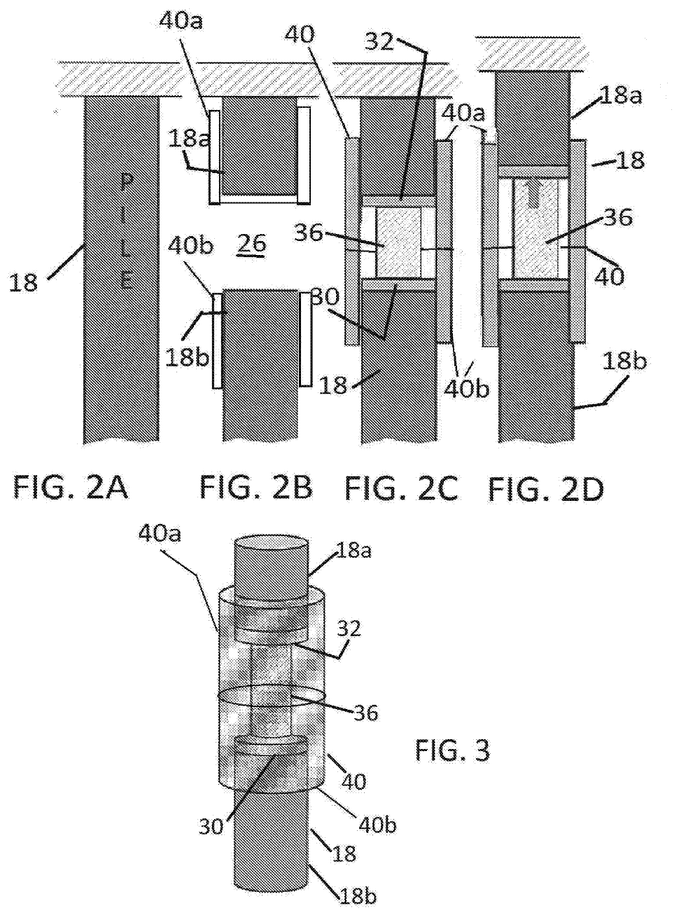

Another method is illustrated in FIGS. 2A to 2D which depicts the actions taken to one pile 18 with the understanding that plural piles would be so modified. In FIG. 2B the pile 18 to be adjusted has the upper section removed creating the vertical gap 26 between an upper portion 18a of the pile 18 and a lower portion 18b of the pile 18. The concrete and the rebar of the pile 18 has been cut through. In FIG. 2C, a sleeve 40 in two pieces (see FIG. 5) is placed over the pile, one portion 40a pushed above the section and one portion 40b below the section. Upper and lower plates 30, 32 are then installed against the exposed faces of the concrete pile within the gap. The plates 30, 32 can be steel plates or steel plates with Neoprene surfaces facing the exposed pile surfaces, or can be elastomeric plates. Neoprene can even out load distribution on the pile, provide load equilibrium between piles and can reduce earthquake impacts.

A jack 36 is located between the plates 30, 32. As shown in FIG. 2D, the jack has been expanded to lift the upper portion 18a of the pile and the slab above the upper portion 18a. Although a raising is illustrated it could just as well be a lowering, by shortening the jack. The two sleeve portions 40a, 40b are brought together and engaged, such as by welding or threading, wherein the assembled sleeve 40 has a length that extends over the gap 26, extending a distance above and below the gap, partly over the upper portion 18a and the lower portion 18b. One or both of the upper portion 40a and the lower portion 40b can be pinned to the lower pile portion 18b or the upper pile portion 18a to prevent vertical displacement.

FIG. 3 illustrates in schematic fashion the arrangement of FIG. 2D.

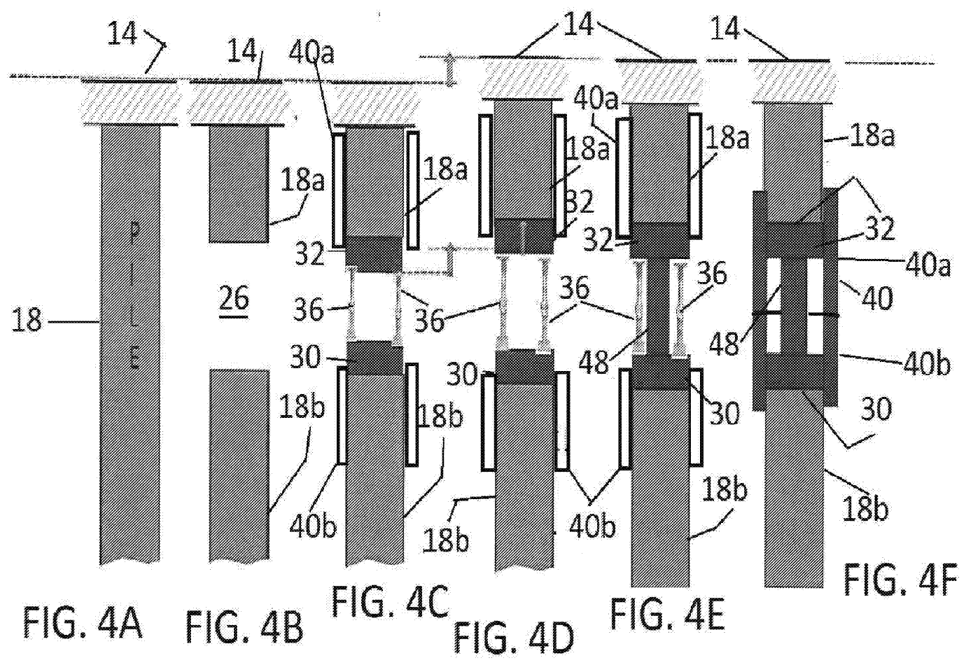

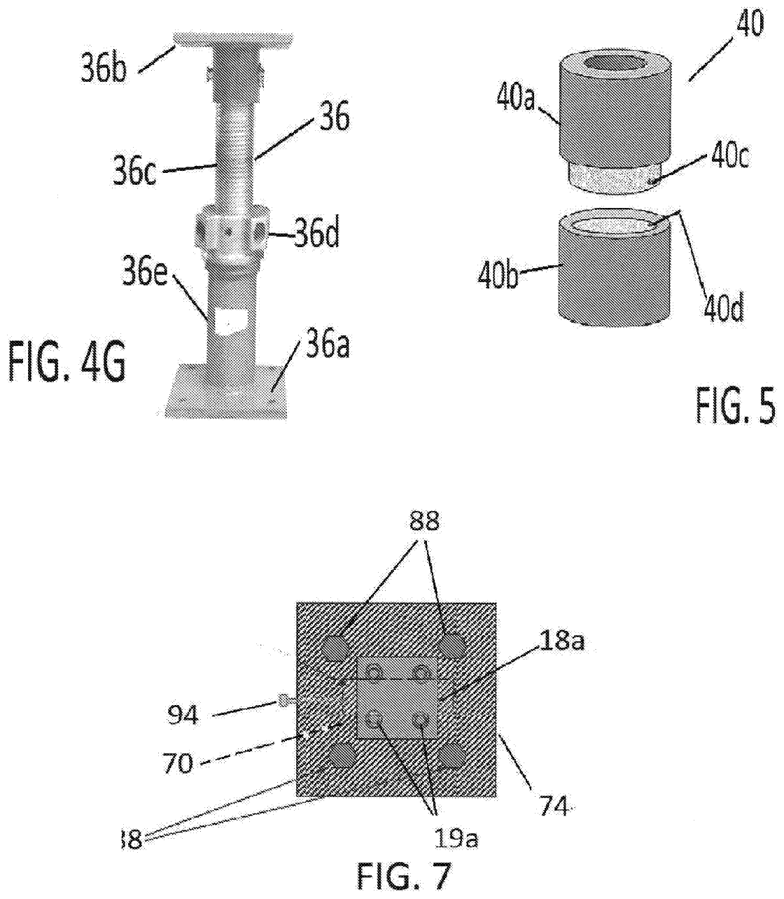

FIGS. 4A through 4F illustrate another method according to the invention. In FIG. 4B the pile 18 to be adjusted has an upper section removed creating the vertical gap 26 between an upper portion 18a of the pile 18 and a lower portion 18b of the pile 18. In FIG. 4C, upper and lower sleeve portions 40a, 40b have been installed and moved above and below the gap 26. Upper and lower plates 30, 32 are installed against the exposed faces of the concrete pile within the gap. The plates 30, 32 can be steel plates or steel plates with Neoprene surfaces facing the exposed pile surfaces, or can be elastomeric plates. Neoprene can even out load distribution on the pile, provide load equilibrium between piles and can reduce earthquake impacts.

One or more jacks 36 are located between the plates 30, 32. As shown in FIG. 4D, the jack has been expanded to lift the upper portion 18a of the pile and the slab above the upper portion 18a. Although a raising is illustrated it could just as well be a lowering, by shortening the jack. In FIG. 4E, shims 48 have been stacked between the plates 30, 32. In FIG. 4F, the jacks 36 are removed and the upper and lower portions 40a, 40b of the sleeve 40 have been brought together and engaged by welding, threading or some other means. The sleeve 40 is placed over the pile and over the gap, extending a distance above and below the gap, partly over the upper portion 18a and the lower portion 18b. One or both of the upper portion 40a and the lower portion 40b can be pinned to the lower pile portion 18b or the upper pile portion 18a to prevent vertical displacement.

FIG. 4G shows one such jack 36 which includes a base 36a separated from a support plate 36b by a threaded column 36c that threads into an inside thread of a threaded turning nut 36d supported on a base column 36e.

FIG. 5 illustrates one type of sleeve 40 that is usable in the aforementioned methods. The sleeve includes the upper portion 40a and the lower portion 40b. The upper portion 40a can have a first cylindrical body with an integral male threaded extension of reduced diameter that extends from one end of the first cylindrical body. The lower portion 40b can have a second cylindrical body having an inside diameter with a female thread. The male threaded sleeve is sized to thread into the female thread of the lower portion such that the first and second cylindrical bodies fit flushly together with the same outside diameter.

Alternatively, the sleeve 40 can comprise an upper and a lower portion that are welded together around their common circumferences, or two half cylinders that are wrapped halfway around the pile and welded together along their two common longitudinal seams.

The sleeve 40 functions to resists lateral and vertical displacement of the upper and lower portions 18a, 18b of the pile 18, particularly against earthquake shear.

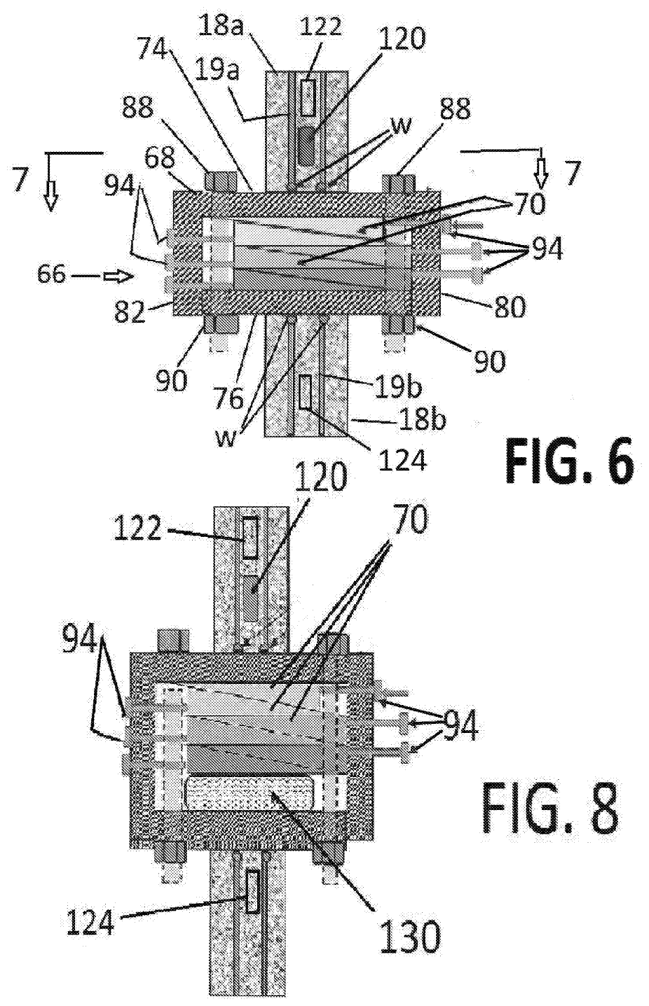

FIGS. 6 and 7 illustrate another method according to the invention. A section 26 (see FIG. 2B or 4B) has been removed from the pile 18 creating the upper portion 18a and the lower portion 18b. A module 66 is assembled in the section. The module 66 includes a housing 68 and associated components inserted between the portions 18a, 18b. Within the housing 68, wedge shaped or tapered shims 70 are stacked in alternating directions between an upper wall 74 and a lower wall 76 of the housing. The upper wall and the lower wall can be welded to exposed rebar 19a, 19b of the upper portion 18a and the lower portion 18b. In this regard, some concrete in the facing portions of the upper portion 18a and the lower portion 18b have been removed around the cut rebars, in order to have good access to the exposed cut ends of the rebars for welding (not shown) to the upper and lower walls 74, 76 respectively. After welding, the concrete around the welds and to the upper and lower walls 74, 76 is replaced with high strength concrete to restore compressive pile integrity.

The housing 68 includes side walls 80, 82 which can be formed as part of the top wall 74. The top wall 74, the shims 70 and the bottom wall are held together by a plurality of studs or bolts 88 and nuts 90, initially in a loosened state to allow an increasing distance between the top and bottom walls during height adjustment. Wedge height adjustment bolts 94 are threaded into the side walls 80, 82 and abut a thick base end of each wedge shim 70. Threading of the adjustment bolts into the housing drives the wedge shaped shims inward and thus increases the distance between the top wall and the bottom wall and elevates the portion 18a. When the desired elevation adjustment is achieved, the nuts 90 are tightened onto the bolts 88 to secure the housing and the shims.

A strain gauge 120 is mounted to the upper portion 18a. Alternatively the strain gauge could be installed to the lower portion 18b. The strain gauge 120 can communicate wirelessly to an external data base or computer which can be reviewed by scientists. Additionally, displacement sensors 122, 124 can be attached to the upper portion 18a and the lower portion 18b to sense differential movement between the sections 18a, 18b, particularly lateral displacements. The sensors 120, 122, 124 communicate wirelessly to a monitoring and/or control computer for study by scientists and engineers. The computer can also be used to control the incremental raising and lowering of upper pile portions 18a of multiple piles using multiple modules 66 based on readings from the strain gauges 120 from the multiple piles, according to a jacking protocol to ensure that differential vertical movements of multiple piles is kept within pre-determined limits to avoid excessive stress in the building structure, the foundation piles and the building foundation slab.

The module 66 may be over-sleeved by the method disclosed in FIGS. 2a-5 i.e., using male and female threaded sections 40a, 40b. Either or both of the anchor plate bolts 88 or the over sleeves 40 are intended to ward off lateral pile section displacement due to pile settling, earthquake, high wind events or the like.

By welding the rebars to the upper and lower walls, tensile pile integrity is restored through the mechanical train of rebar-to-anchor plate, anchor plate-to-anchor plate, anchor plate-to-rebar.

The strain gauges 120 can be attached to the piles prior to sections 26 removal, and calibrated to a zero baseline. Once the section 26 is removed, the interposing module 66 may be adjusted to exert an upward force on the upper portion of the pile to first reestablish the original static load and then a further upward force is exerted to allow an incremental increase of the upper pile elevation to a predetermined level according to the jacking protocol for the building.

The module 66 is intended to be one of a large group of pile elevating means such that entire structures may be permanently elevated or leveled by means of sequential and coordinated module adjustment. A computer can coordinate the incremental raising or lowering of multiple modules such that excessive stress in the foundation slab 14, the piles and the building structure is avoided.

By knowing the original strain in a pile before raising the upper portion of the pile, and then restoring that exact strain level after raising, there should be no additional stress on the foundation slab. A slightly higher stress may be added to that portion of the slab by raising the upper portion of the pile, but not enough to distort the slab 14 to the point of cracking. This slightly higher stress can be calculated beforehand.

Repeated in a finite elemental analysis-based sequence for selected multiple piles, a collective upward thrust will be developed causing the building tilt to be remediated. Alternatively, the entire slab can be lifted if needed, such as in the event of rising waters, etc.

The raising or jacking protocol can be an iterative process that's guided by the strain sensor readings of multiple piles and a computer algorithm, necessary to make sure that slab strain is minimized. The system will result in a stress matrix of all affected piles from the strain sensors of the individual piles. This would lend itself to computerized adjustment matrices to minimize building distortion or racking during corrective jacking. Racking is the architectural term for the out-of-square twisting distortion that could accrue from uneven jacking. Girder framed buildings are greatly weakened by racking due to the lack of motion accommodation at the rigid right angle joints between floor and riser girders.

Most readily controlled by computer controlled actuators, the raising or jacking process could still be carried out by hand by following a strain and pile sequence protocol.

Employing strain sensors 120 for calibrating compressive stress adjustments would be advantageous in avoiding unbalanced pile adjustments that could lead to building racking and other structural distortions.

Module thickness or height to bearing area should be minimized for lateral stability purposes.

As shown in FIG. 8, an elastomeric shock absorber 130 can be placed beneath the shims. This may be an advantageous feature in an earthquake situation.

According to the exemplary embodiments of the invention, both tracking and alleviating seismic disturbances and their effects on the building structure can be accommodated. The strain gauge 120 can track stresses during progressive pile elevation adjustments as described above, and wireless instant feedback would be useful in gauging the post-shock structural integrity during the “red-tag” assessment phase of evaluation. Wireless feedback would avoid the signal loss likely from hard-wired systems that are prone to disruption during such events.

Displacement sensors 122, 124 linking upper and lower sections of the piles would be able to track any tangible vertical and lateral displacements inflicted on the pile elevation module. In addition, a “p-wave” sensor, one that detects the preliminary vertical seismic oscillation that precedes the more destructive lateral and structure-destroying seismic “s-waves”, may be configured to activate otherwise dormant strain and displacement sensors.

Rebar reinforced piles are rigid and the constituent concrete component can shatter from over-stressing seismic events, thereby losing much of their structural integrity. A modification to the elevation module that permits slight lateral displacement accommodation could buffer the adjacent pile sections from some of the peak stresses during s-wave occurrences.

Adjustment of the elevation module to equalize pile strain with its neighbors using the strain gauges 120 can expedite implementation. Furthermore, according to one aspect, by leaving jacks, and/or tapered shims in place, periodic shim replacement or adjustment can be made to adjust elevation as earth settling of the piles progresses, as evidenced by continuous readings of the strain gauges.

The raising of multiple piles using a controlled sequence and strain gauges 120 as well as the use of displacement sensors 122, 124 for lateral displacement monitoring are described above with respect to the embodiments of FIGS. 6-8 but could also be used in the embodiments of FIGS. 1-6.

According to another aspect, for any of the above-described embodiments, once elevation adjustments are complete, any voids between the upper portion 18a and the lower portion 18b of the pile can be filled with grout to further stabilize the pile. Provisions can be made in the sleeve 40 and/or the housing 68 to receive pressurized grout.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A method of leveling a foundation slab supported on piles, comprising the steps of:
cutting an upper section from one or more piles, exposing facing surfaces of an upper pile portion and a lower pile portion;
arranging at least one raising device between the facing surfaces;
activating the raising device to lift the upper pile portion with respect to a lower portion.

2. The method according to claim 1, wherein the raising device comprises a hydraulic jack.

3. The method according to claim 1, wherein the raising device comprises a screw jack.

4. The method according to claim 1, wherein the raising device comprises a stack of wedges that are driven inwardly to increase the height of the stack.

5. The method according to claim 1, wherein after the raising device is activated, one or more shims are placed between the facing surfaces.

6. The method according to claim 1, wherein a sleeve is placed around the cut out section for providing lateral support between upper and lower pile portions and vertical support to resist vertical separation between upper and lower pile portions.

7. The method according to claim 6, wherein the sleeve is composed of steel.

8. The method according to claim 6, wherein the sleeve comprises an upper sleeve portion and a lower sleeve portion, wherein each sleeve portion is moved though the cut out section and displaced upward for the upper sleeve portion and downward for the lower sleeve portion, before the raising device is located in the cut out section and thereafter the upper sleeve portion and the lower sleeve portion are vertically brought together and interlocked.

9. The method according to claim 8, wherein the upper sleeve portion has a first thread and the lower sleeve portion has a second thread that threads together with the first thread when the upper sleeve portion and the lower sleeve portion are relatively rotated about the vertical axis.

10. The method according to claim 6 wherein at least one of the upper sleeve portion and the lower sleeve portion are fixed to at least one of the upper pile portion and the lower pile portion.

11. The method according to claim 1 comprising the step of measuring the strain relief of the pile as it is cut for removing the section.

12. The method according to claim 1 wherein the raising device is a screw jack.

13. The method according to claim 1 wherein the raising device is a stack of wedge shaped shims, wherein relatively horizontally displacing the shims within the stack raises the overall height of the stack.

14. The method according to claim 1, wherein a plurality of displacement sensors are located on plural upper pile portions to be raised or lowered, wherein as the raising device is raised or lowered, the elevations of each of the upper pile portions is monitored by a computer.

15. The method according to claim 14, wherein the computer also controls the raising devices.

16. The method according to claim 15, wherein the computer controls the raising devices to create a strain matrix to enable a building adjustment that does not exceed pre-determined stress limits for the building structure, the building foundation slab or the foundation piles.

17. An apparatus for leveling a foundation slab supported on piles, at least one pile having a section removed for accommodating the apparatus, comprising:
a raising device that comprises a hydraulic jack, or a screw jack, or a stack of wedges that are driven inwardly to increase the height of the stack.

18. The apparatus according to claim 17, further comprising a sleeve placed around the removed section for providing lateral support between upper and lower pile portions and vertical support to resist vertical separation between upper and lower pile portions.

19. The apparatus according to claim 18, wherein the sleeve is composed of steel.

20. The apparatus according to claim 18, wherein the sleeve comprises an upper sleeve portion and a lower sleeve portion, wherein each sleeve portion is sized and configured to move though the removed section and be displaced upward for the upper sleeve portion and downward for the lower sleeve portion, before the raising device is located in the removed section and thereafter the upper sleeve portion and the lower sleeve portion have formations to be vertically brought together and interlocked.

21. The apparatus according to claim 20, wherein the upper sleeve portion has a first thread and the lower sleeve portion has a second thread that threads together with the first thread when the upper sleeve portion and the lower sleeve portion are relatively rotated about the vertical axis.

22. The apparatus according to claim 20 wherein at least one of the upper sleeve portion and the lower sleeve portion are fixed to at least one of the upper pile portion and the lower pile portion.

23. The apparatus according to claim 17 comprising a strain gauge for measuring the strain relief of the pile as the section is removed.

24. The apparatus according to claim 17, further comprising a computer and a plurality of displacement sensors located on plural upper pile portions to be raised or lowered, wherein as the raising device is raised or lowered, the elevations of each of the upper pile portions is monitored by the computer.

25. The apparatus according to claim 24, wherein the computer also controls the raising devices.

26. The apparatus according to claim 25, wherein the computer controls the raising devices to create a strain matrix to enable a building adjustment that does not exceed pre-determined stress limits for the building structure, the building foundation slab or the foundation piles.
